(19) United States
(12) Patent Application Publication
(10) Pub. No.: US 2017/0028539 A1
(43) Pub. Date: Feb. 2, 2017

(54) FAST TORQUE-SWITCHABLE TORQUE WRENCH

(71) Applicant: KABO TOOL COMPANY, Taichung City (TW)

(72) Inventor: Chih-Ching HSIEH, Taichung City (TW)

(21) Appl. No.: 15/155,344

(22) Filed: May 16, 2016

(30) Foreign Application Priority Data
Jul. 27, 2015 (TW) 104124290

(51) Int. Cl. B25B 23/142; B25B 23/14; B25B 13/46

(52) U.S. Cl. CPC B25B 23/1427; B25B 13/463; B25B 23/141

(57) ABSTRACT

A fast torque-switchable torque wrench includes a tubular body, a hollow handle disposed at a rear end of the tubular body, a first restriction section and a second restriction section disposed in the tubular body and a threaded rod disposed in the handle. The longitudinal moving distance of the threaded rod is limited by the first and second restriction sections. When rotating the handle, the torque of the wrench is adjusted. The longitudinal displacement of the threaded rod is limited so as to control the rotational range of the handle, whereby a user can quickly adjust the torque value of the torque wrench.

### BACKGROUND OF THE INVENTION

1. Field of the Invention

The present invention relates generally to a wrench, and more particularly to a fast torque-switchable torque wrench.

2. Description of the Related Art

It is known that a torque wrench is used to tighten/untighten a threaded member. The torque wrench can be set with a torque value to control the tightening extent of the threaded member. Especially, some specific or important apparatuses have high-precision components that need to be precisely tightened to an extent. Therefore, the torque wrench is preset with a torque value so as to precisely tighten the high-precision components in accordance with the necessary mechanical characteristics and the security regulation.

Generally, in a conventional torque wrench, a handle is rotated to adjust the torque value of the torque wrench. The torque wrench has a wide range of adjustable torque and is applicable to most of the wrenching operation. However, the conventional torque wrench has a wide range of adjustable torque so that the torque value is adjusted by a very slow rate. A user often needs to rotate the handle many times for adjusting the torque wrench to the necessary torque value. In use, the conventional torque wrench is inconvenient. To speak further, in case a user needs to tighten multiple threaded members with different torque values at the same time, the user inevitably must frequently rotate the handle for switching the torque wrench between different torque values. That is, the handle must be rotated many times for switching the torque values. This not only costs a very long time, but also slows down the working procedure. Also, a user often feels impatient due to the tedious switching process.

Furthermore, in practice, the necessary torque values of the conventional torque wrench are often some fixed specific torque values. For example, the often used torque values for a tire worker to tighten a wheel are 90, 110 and 130 Nm. The conventional torque wrench cannot be fast switched between these specific torque values. This fails to meet the practical operation requirements and needs to be improved.

### SUMMARY OF THE INVENTION

It is therefore a primary object of the present invention to provide a torque wrench. The torque values of the torque wrench can be quickly switched to enhance the convenience of the torque wrench.

To achieve the above and other objects, the fast torque-switchable torque wrench of the present invention includes:

a tubular body;

a working head disposed at a front end of the tubular body;

a trip mechanism disposed in the tubular body and positioned at a rear end of the working head, whereby when the application force of the torque wrench reaches a set torque value, the trip mechanism provides a tripping effect;

an elastic member disposed in the tubular body, the elastic member elastically abutting against the trip mechanism;

a first restriction section and a second restriction section disposed in the tubular body and positioned behind the elastic member;

a hollow handle, a front end of the handle being fitted with a rear end of the tubular body, the handle being rotatable on the tubular body;

a threaded rod having a main body, a thread being formed on an outer circumference of the main body, the main body of the threaded rod being disposed in the tubular body, a front end of the threaded rod directly or indirectly pressing the elastic member, the handle being connected with a rear end of the threaded rod, whereby when rotating the handle, the threaded rod being driven to move in a longitudinal direction of the tubular body;

a stop section connected with the main body of the threaded rod, the stop section being positioned in front of the first restriction section; and

a restriction component disposed on the main body of the threaded rod and positioned behind the second restriction section, the threaded rod being movable in the longitudinal direction of the tubular body between a front dead end and a rear dead end, when the threaded rod is positioned in the front dead end, the restriction component being stopped by the second restriction section, when the threaded rod is positioned in the rear dead end, the stop section being stopped by the first restriction section.

According to the above arrangement, by means of the first and second restriction sections, the stop section and the restriction component, the displacement of the threaded rod is settable to set the adjustable torque value of the torque wrench within a range. In this case, a user can quickly adjust the torque value of the torque wrench to enhance the utility and convenience of the torque wrench.

The present invention can be best understood through the following description and accompanying drawings, wherein:

### BRIEF DESCRIPTION OF THE DRAWINGS

FIG. 1 is a perspective view of a first embodiment of the torque wrench of the present invention;

FIG. 2 is a longitudinally sectional view of the first embodiment of the torque wrench of the present invention according to FIG. 1;

FIG. 3 is a sectional view taken along line 3-3 of FIG. 2;

FIG. 4 is a perspective exploded view of the first embodiment of the torque wrench of the present invention according to FIG. 1;

FIG. 5 is an enlarged exploded view of the front and rear fixing members and the connection member of FIG. 4;

FIG. 6 is an enlarged view of a part of the torque wrench of FIG. 2, showing that the threaded rod is positioned in the rear dead end;

FIG. 7 is a sectional view taken along line 7-7 of FIG. 6;

FIG. 8 is a view according to FIG. 6, showing that the engagement member is positioned in the releasing position;

FIG. 9 is a sectional view taken along line 9-9 of FIG. 8;

FIG. 10 is a view according to FIG. 6, showing that the threaded rod is positioned in the front dead end;

FIG. 11 is a view according to FIG. 10, showing that the engagement member is positioned in the engagement position;

FIG. 12 is a view according to FIG. 6, showing that the gap D between the restriction member and the restriction component is adjusted; and

FIG. 13 is an enlarged sectional view of a part of a second embodiment of the torque wrench of the present invention.

### DETAILED DESCRIPTION OF THE PREFERRED EMBODIMENTS

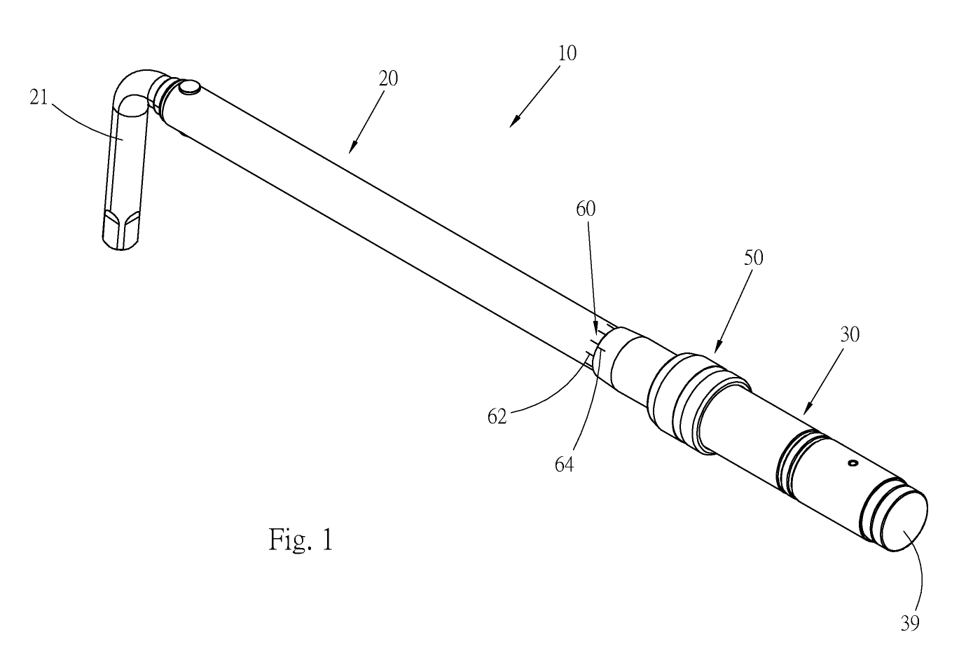

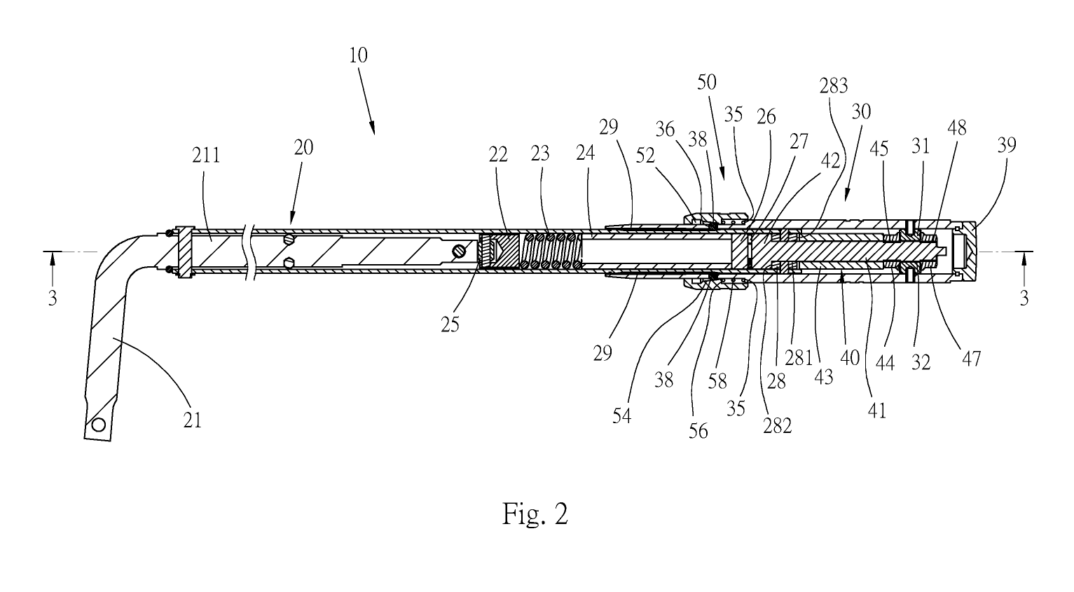

Please refer to FIGS. 1 to 4. According to a first embodiment, the fast torque-switchable torque wrench 10 of the present invention includes: a tubular body 20. The tubular body 20 has a working head 21, an abutment member 22, an elastic member 23, a slide member 24, a trip mechanism, an abutment block 26, a bearing 27, a restriction member 28 and multiple locating slots 29. The rear end of the working head 21 has a rod body 211. The rod body 211 is fitted in a front end of the tubular body 20. The abutment member 22 is disposed in the tubular body 20 behind the rod body 211 of the working head 21. The slide member 24 is movably disposed in the tubular body 20 behind the abutment member 22. The elastic member 23 is disposed between the abutment member 22 and the slide member 24. Two ends of the elastic member 23 respectively elastically abut against a rear end of the abutment member 22 and a front end of the slide member 24. The abutment block 26 is disposed behind the slide member 24 in contact with the rear end face of the slide member 24. The bearing 27 is disposed behind the abutment block 26 in contact with the rear end face of the abutment block 26. The restriction member 28 is formed with a through hole 281, a first restriction section 282 and a second restriction section 283. The through hole 281 extends in a longitudinal direction of the restriction member 28. A thread is formed on an inner circumferential wall of the through hole 281. The first restriction section 282 is formed on the front end face of the restriction member 28. The second restriction section 283 is formed on the rear end face of the restriction member 28. The restriction member 28 is fixedly disposed in the tubular body 20 by means of two insertion pins and positioned at the rear end of the tubular body 20. The locating slots 29 are annularly disposed on the outer circumference of the rear end of the tubular body 20 and extend in the longitudinal direction of the tubular body 20. The trip mechanism is a trip member 25 disposed between the rod body 211 and the abutment member 22. When the torque wrench 10 reaches the set torque value, the trip member 25 will achieve a tripping effect and make the torque wrench 10 vibrate or sound so as to alert a user that the torque wrench 10 has reached the preset torque. The trip mechanism is a conventional component. Various trip mechanisms can be applied to the torque wrench of the present invention. The trip mechanism applied to the present invention is not limited to what described in this embodiment.

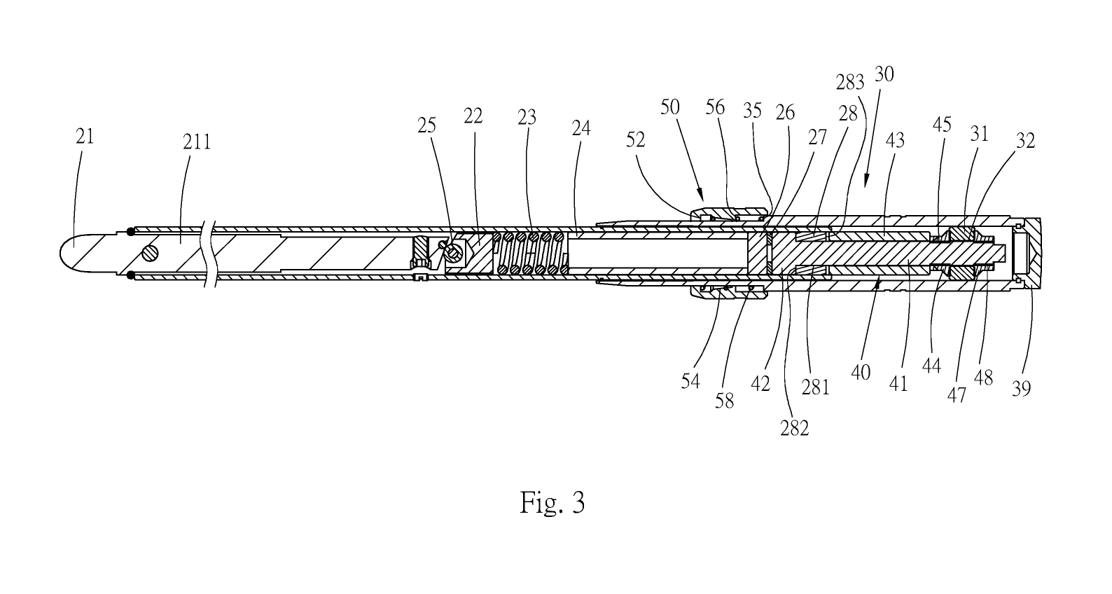

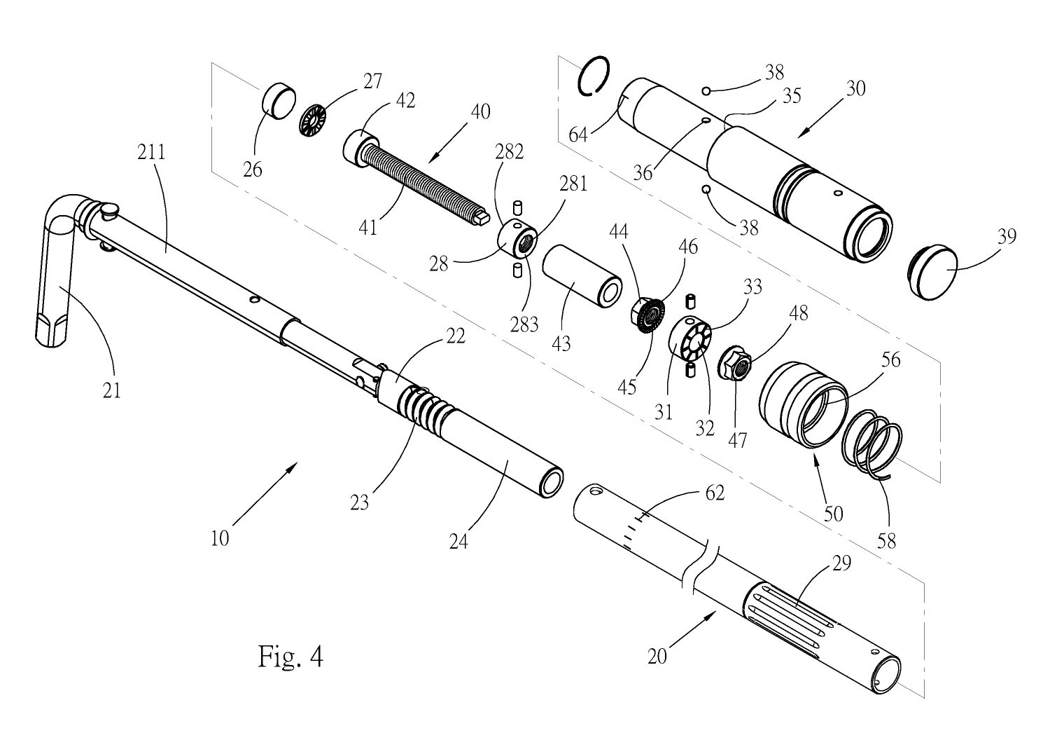

A hollow handle 30 having a connection member 31, a shoulder section 35, two perforations 36, two locating members 38 and a cap member 39. The connection member 31 is formed with a longitudinal through hole 32. The front end face and rear end face of the connection member 31 are respectively formed with multiple teeth 33 as shown in FIGS. 3 and 4. The connection member 31 is fixedly disposed in the handle 30 by means of two insertion pins and positioned at a rear end of the handle 30. The shoulder section 35 is annularly formed on an outer circumference of the handle 30. The two perforations 36 are formed through the front end of the handle 30 in the radial direction thereof. In this embodiment, the two locating members 38 are ball-shaped and respectively slidably disposed in the two perforations 36. The cap member 39 is disposed at the rear end of the handle 30. The front end of the handle 30 is fitted with the rear end of the tubular body 20. The handle 30 is rotatable around the tubular body 30.

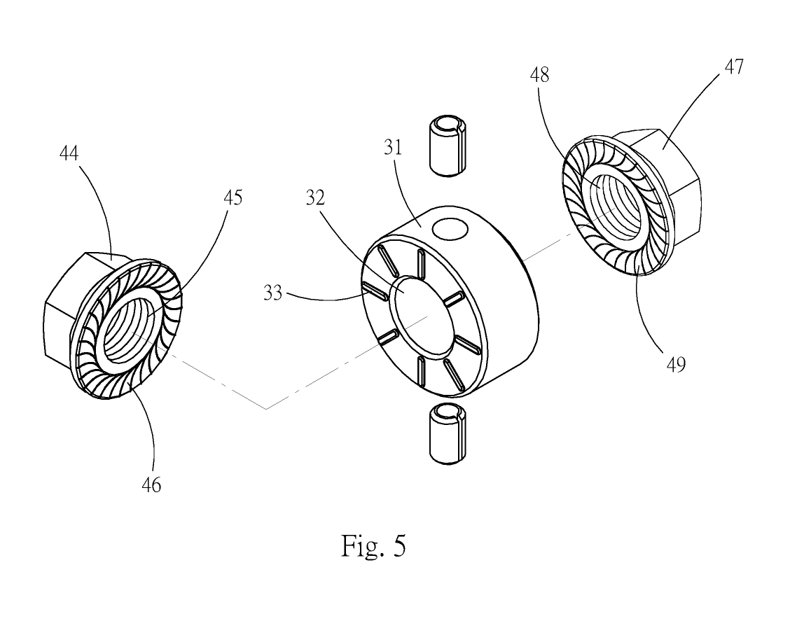

A threaded rod 40 having a main body 41, a stop section 42, a restriction component, a front fixing member 44 and a rear fixing member 47. A thread is formed on an outer circumference of the main body 41. In this embodiment, the stop section 42 is a head section connected with the front end of the main body 41. In this embodiment, the restriction component is a restriction member 43. The restriction member 43 is a tubular member disposed on the main body 41 of the threaded rod 40 by means of screwing or fitting. In this embodiment, the restriction member 43 is slidable along the threaded rod 40. The threaded rod 40 is disposed in the handle 30 with the main body 41 fixedly connected with the handle 30. A front end of the threaded rod 40 is screwed in the through hole 281 of the restriction member 28. A rear end of the threaded rod 40 is passed through the through hole 32 of the connection member 31. The stop section 42 is positioned between the bearing 27 of the tubular body 20 and the first restriction section 282 of the restriction member 28. The front end face of the stop section 42 is in contact with the rear end face of the bearing 27. When the threaded rod 40 is rotated, the bearing 27 enables the threaded rod 40 to more smoothly rotate. In practice, the slide member 24, the abutment block 26 and the bearing 27 in the tubular body 20 can be omitted. Instead, the stop section 42 of the threaded rod 40 directly abuts against and compresses the elastic member 23. The restriction member 43 is positioned behind the second restriction section 283 of the restriction member 28. Please refer to FIGS. 4 and 5. The front and rear fixing members 44, 47 and the connection member 31 of the handle 30 are assembled into a connection assembly. Each of the front and rear fixing members 44, 47 is formed with a longitudinal threaded hole 45, 48. The rear end face of the front fixing member 44 and the front end face of the rear fixing member 47 are respectively formed with multiple first ratchets 46 and multiple second ratchets 49. The first and second ratchets 46, 49 are arranged in reverse directions. The front and rear fixing members 44, 47 are both screwed on the main body 41 of the threaded rod 40. The front fixing member is positioned between the restriction member 43 and the connection member 31. The front end face of the front fixing member 44 abuts against the rear end face of the restriction member 43. The first ratchets 46 are engaged with the teeth 33 of the front end face of the connection member 31. The rear fixing member 47 is positioned behind the connection member 31. The second ratchets 49 are engaged with the teeth 33 of the rear end face of the connection member 31.

The teeth 33 of the front end face of the connection member 31 are engaged with the first ratchets 46 of the front fixing member 44 or the teeth 33 of the rear end face of the connection member 31 are engaged with second ratchets 49 of the rear fixing member 47. Therefore, when the handle 30 is rotated, the threaded rod 40 is rotated with the handle 30. The main body 41 of the threaded rod 40 is screwed with the restriction member 28. Therefore, when the threaded rod 40 is rotated, the threaded rod 40 is moved back and forth in the longitudinal direction of the tubular body 20 so as to adjust the torque value of the torque wrench 10.

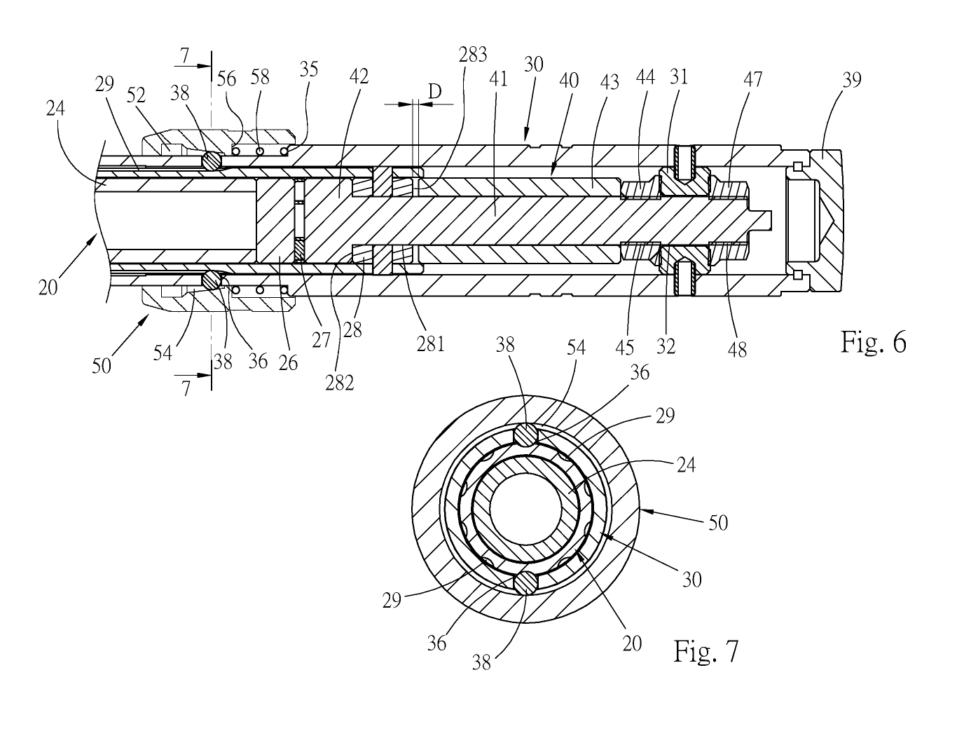

The threaded rod 40 is movable in the longitudinal direction of the tubular body 20 between a front dead end and a rear dead end. When the threaded rod 40 of the torque wrench 10 is positioned in the rear dead end, the rear end face of the stop section 42 of the threaded rod 40 abuts against the first restriction section 282 of the restriction member 28, whereby the threaded rod 40 is prevented from further moving backward. Under such circumstance, the torque value of the torque wrench 10 cannot be further lowered. At this time, a gap D is defined between the front end of the restriction member 43 of the threaded rod 40 and the second restriction section 283 of the restriction member 28 as shown in FIG. 6. When the threaded rod 40 of the torque wrench 10 is positioned in the front dead end, the stop section 42 of the threaded rod 40 pushes the slide member 24 to compress the elastic member 23 and a gap D is defined between the stop section 42 and the first restriction section 282 of the restriction member 28. The front end of the restriction member 43 abuts against the second restriction section 283 of the restriction member 28 to prevent the threaded rod 40 from further moving forward. Under such circumstance, the torque value of the torque wrench 10 cannot be further increased.

An engagement member 50 fitted on the outer circumference of the front end of the handle 30. The engagement member 50 is movable in the longitudinal direction of the handle 30. The engagement member 50 has an engagement position and a releasing position. A receiving section 52, a fastening section 54 and a raised section 56 are disposed on an inner circumference of the engagement member 50. The receiving section 52 is annularly disposed on a front side of the inner circumference of the engagement member 50. The fastening section 54 is a slope annularly disposed on the inner circumference of the engagement member 50. The depth of the fastening section 54 is gradually increased from the rear end of the engagement member 50 to the front end of the engagement member 50 to reach the receiving section 52. The raised section 56 is annularly disposed on the rear end of the inner circumference of the engagement member 50. A spring 58 with higher elastic coefficient is disposed between the raised section 56 of the engagement member 50 and the shoulder section 35 of the handle 30. Two ends of the spring 58 respectively elastically abut against the raised section 56 and the shoulder section 35.

A torque indication position 60 disposed at the junction between the tubular body 20 and the handle 30. The torque indication position 60 has multiple scales 62 and an indicator section 64. The scales 62 represent the torque values of the torque wrench 10. The number of the scales 62 is equal to the number of the locating slots 29 of the tubular body 20. The scales 62 are disposed on the outer circumference of the tubular body 20. The indicator section 64 is disposed on the front end of the handle 30 in alignment with the scales 62.

When the engagement member 50 is positioned in the engagement position, the fastening section 54 pushes and presses the two locating members 38 to make the two locating members 38 engaged in two locating slots 29. Under such circumstance, the handle 30 cannot be rotated. When the engagement member 50 is moved to the releasing position, the engagement member 50 is pulled backward in the longitudinal direction of the handle 30 and the raised section 58 of the engagement member 50 is moved to get closer to the shoulder section 35 of the handle 30 and compress the spring 58. In addition, the two locating members 38 are aligned with the receiving section 52 of the engagement member 50 to leave the locating slots 29 of the tubular body 20 and move into the receiving section 52 of the engagement member 50. In this case, the handle 30 is rotatable around the tubular body 20. When the handle 30 is rotated, the two locating members 38 will move into and out of the locating slots 29 many times to provide a locating feeling. Moreover, the locating slots 29 are respectively aligned with the scales 62. Therefore, from the locating feeling, a user can know that the torque wrench 10 has been switched to the torque value indicated by the scales 62. When the engagement member 50 is restored to the engagement position, the user only needs to release the engagement member 50. At this time, the elastic force of the spring 58 will bound the engagement member 50 forward, whereby the fastening section 54 of the engagement member 50 fixedly presses the two locating members 38 and again makes the two locating members 38 engaged in two locating slots 29. Under such circumstance, the handle 30 is fixedly engaged with the tubular body 20 and cannot be rotated so as to fix the torque value of the torque wrench 10.

The use state of the torque wrench 10 of the present invention will be described hereinafter.

Please refer to FIGS. 6 and 7. When the threaded rod 40 of the torque wrench 10 is positioned in the rear dead end, a gap D is defined between the front end of the restriction member 43 of the threaded rod 40 and the second restriction section 283 of the restriction member 28. The rear end face of the stop section 42 abuts against the first restriction section 282 of the restriction member 28 so that the threaded rod 40 cannot be moved backward and the torque value of the torque wrench 10 cannot be further lowered. At this time, the elastic member 23 compresses the trip mechanism with a lower elastic force. When the engagement member 50 is positioned in the engagement position, the fastening section 54 pushes and presses the two locating members 38 to make the two locating members 38 engaged in two locating slots 29. In this case, the handle 30 cannot be rotated.

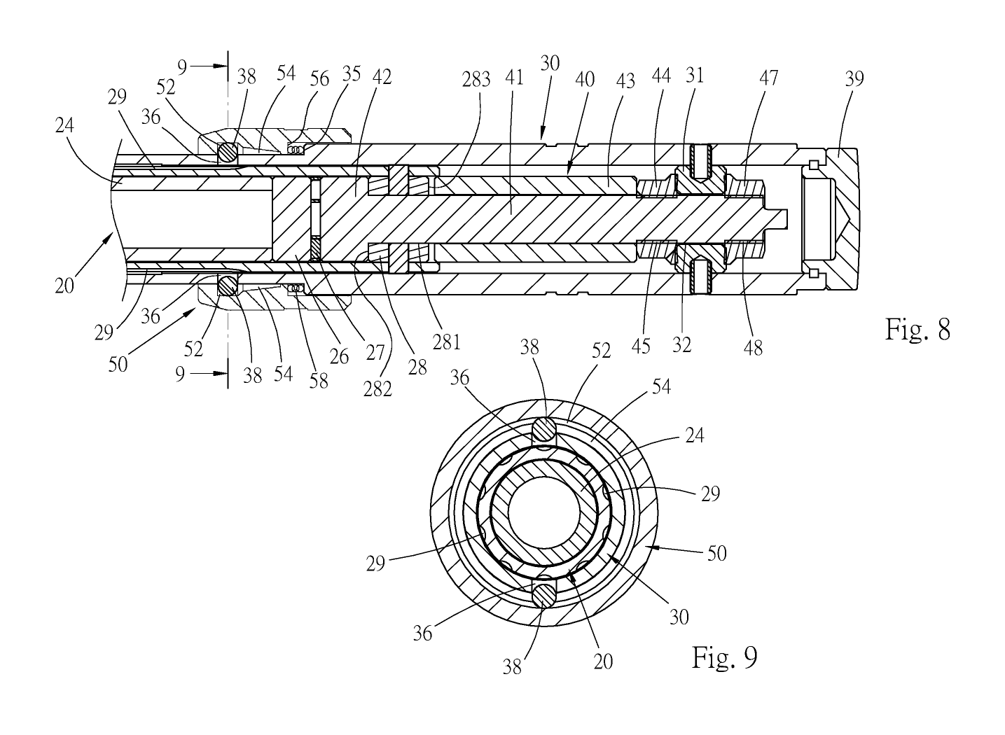

Please refer to FIGS. 8 and 9. When it is desired to adjust the torque of the torque wrench 10, the engagement member 50 is pulled backward to the releasing position in the longitudinal direction of the handle 30. At this time, the raised section 58 of the engagement member 50 is moved to get closer to the shoulder section 35 of the handle 30 and compress the spring 58. In addition, the two locating members 38 are aligned with the receiving section 52 of the engagement member 50 to leave the locating slots 29 of the tubular body 20 and move into the receiving section 52 of the engagement member 50. In this case, the handle 30 is rotatable to adjust the torque of the torque wrench 10.

When the handle 30 is rotated, the two locating members 38 will move into and out of the locating slots 29 many times to provide a locating feeling. Moreover, the locating slots 29 are respectively aligned with the scales 62. Therefore, from the locating feeling, a user can know that the torque wrench 10 has been switched to the torque value indicated by the scales 62.

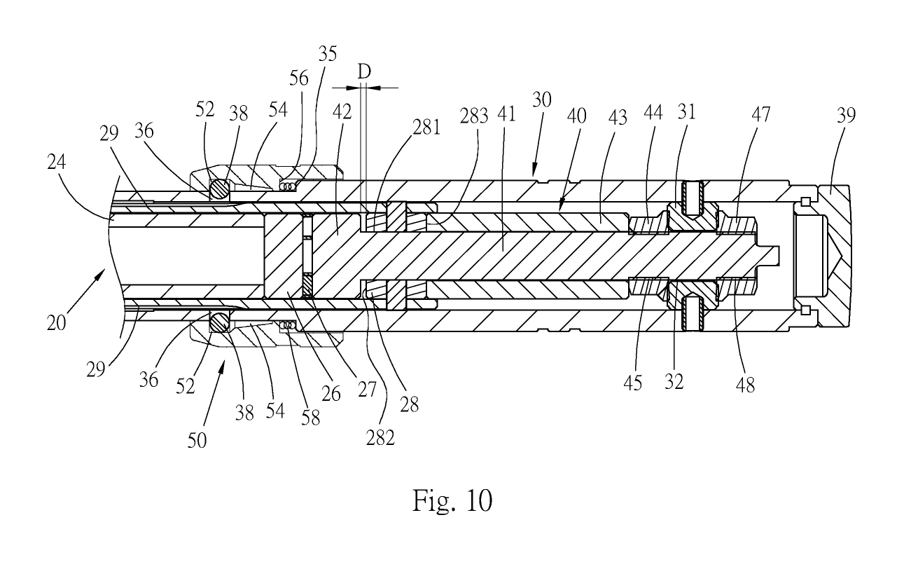

Please refer to FIG. 10. When the threaded rod 40 of the torque wrench 10 is moved to the front dead end, the stop section 42 of the threaded rod 40 pushes the slide member 24 to compress the elastic member 23, the elastic member 23 compresses the trip mechanism with a higher elastic force, and a gap D is defined between the stop section 42 and the first restriction section 282 of the restriction member 28. The front end of the restriction member 43 abuts against the second restriction section 283 of the restriction member 28 to prevent the threaded rod 40 from further moving forward. Under such circumstance, the torque of the torque wrench 10 cannot be further increased.

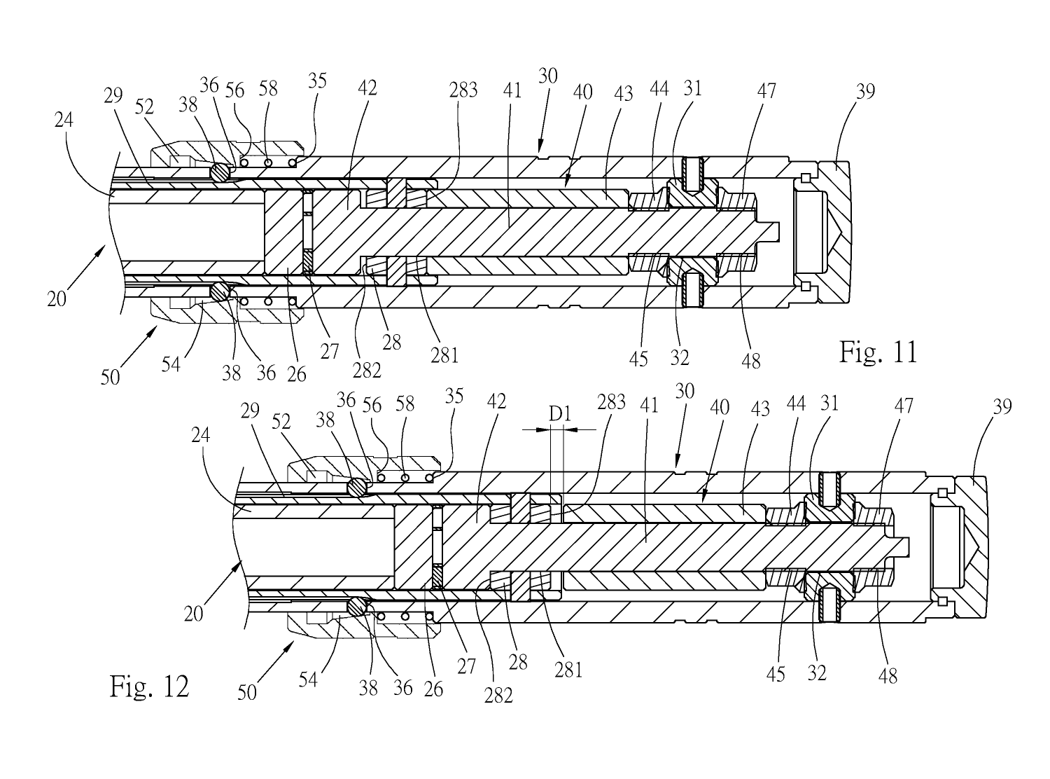

Please refer to FIG. 11. After the torque wrench 10 is switched to the necessary torque value, the engagement member 50 is released. At this time, the elastic force of the spring 58 will bound the engagement member 50 forward to the engagement position, whereby the fastening section 54 of the engagement member 50 fixedly presses the two locating members 38 and again makes the two locating members 38 engaged in two locating slots 29. Under such circumstance, the handle 30 is fixedly engaged with the tubular body 20 and cannot be rotated so as to fix the torque value of the torque wrench 10.

Accordingly, in the torque wrench 10 of the present invention, the displacement of the threaded rod 40 is set by means of the restriction member 28 of the tubular body 20 and the stop section 42 and the restriction member 43 of the threaded rod 40. In this case, the torque value of the torque wrench 10 can be adjusted only within a smaller range. For example, in this embodiment, the torque wrench 10 is set that the handle 30 can be rotated within a range of one circle to adjust the torque value. Therefore, a user can quickly switch the torque wrench 10 to the necessary torque. In this case, the utility of the torque wrench 10 is enhanced.

Moreover, when the handle 30 is rotated, the two locating members 38 will move into and out of the locating slots 29 many times to provide a locating feeling. From the locating feeling, a user can know that the torque wrench 10 has been switched to the torque value indicated by the scales 62. The scales 62 of the torque indication position 60 are aligned with the locating slots 29 of the tubular body 20. Therefore, the torque values of the scales 62 can be set the usually used torque values. By means of the locating feeling, the user can quickly switch the torque wrench 10 between the usually used torque values. Therefore, the torque wrench 10 can be quickly switched to the necessary torque to enhance the convenience of the torque wrench 10.

It should be noted that in the manufacturing process of the torque wrench 10, the gap D between the restriction member 43 and the restriction member 28 is adjustable by means of the two fixing members 44, 47 so as to set the range of the adjustable torque of the torque wrench 10. For example, as shown in FIG. 12, when the two fixing members 44, 47 are disposed in a position near the rear end of the threaded rod 40, the gap D1 between the restriction member 43 and the second restriction section 283 of the restriction member 28 can be increased to enlarge the range of the adjustable torque of the torque wrench 10. Reversely, when the two fixing members 44, 47 are disposed in a position near the front end of the threaded rod 40, the gap between the restriction member 43 and the second restriction section 283 of the restriction member 28 is shortened to minify the range of the adjustable torque of the torque wrench 10.

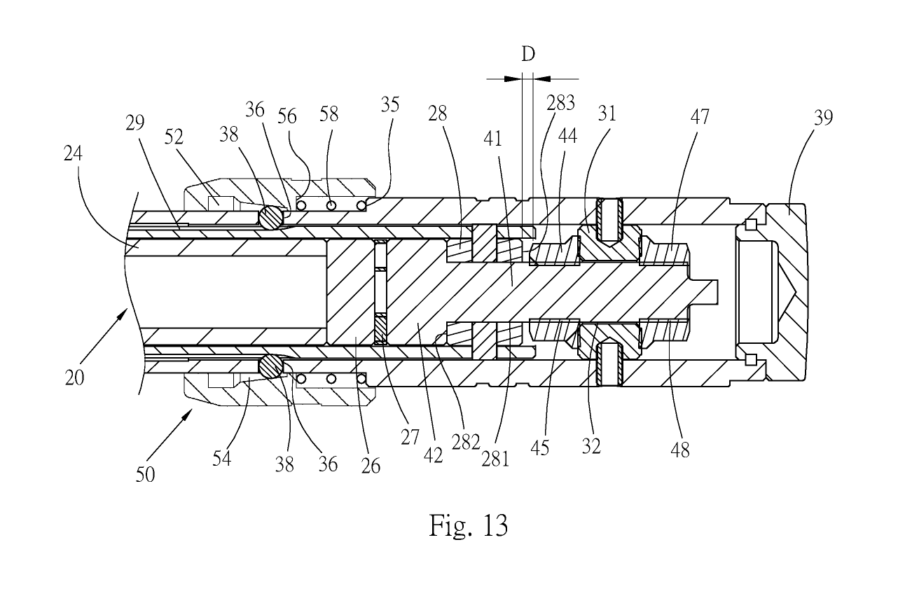

Please refer to FIG. 13, which shows a second embodiment of the torque wrench 10 of the present invention. In this embodiment, the torque wrench 10 of the present invention also includes a tubular body 20, a handle 30, a threaded rod 40, an engagement member 50 and a torque indication position 60. The same components are denoted with the same reference numerals and will not be repeatedly described hereinafter. The second embodiment is different from the first embodiment in that in the second embodiment, the restriction component is the front fixing member 44. The second embodiment is operated in same manner as the first embodiment. When the threaded rod 40 is positioned in the rear dead end, the rear end face of the stop section 42 abuts against the first restriction section 282 of the restriction member 28, whereby the threaded rod 40 is prevented from moving backward. Under such circumstance, the torque value of the torque wrench 10 cannot be further lowered. At this time, a gap D is defined between the second restriction section 283 of the restriction member 28 and the front fixing member 44. When the threaded rod 40 is positioned in the front dead end, the front end face of the front fixing member 44 abuts against the second restriction section 283 of the restriction member 28 to prevent the threaded rod 40 from moving forward. Under such circumstance, the torque value of the torque wrench 10 cannot be further increased.

Accordingly, by means of the structure of this embodiment, the torque value of the torque wrench 10 also can be adjusted within a predetermined range to enhance the utility and convenience of the torque wrench 10.

The above embodiments are only used to illustrate the present invention, not intended to limit the scope thereof. Many modifications of the above embodiments can be made without departing from the spirit of the present invention. For example, the threaded rod can be alternatively fixedly disposed in the handle by means of insertion pins. Alternatively, the through hole of the restriction member is free from the thread. Instead, a threaded member is fixedly disposed in the handle to screw with the threaded rod, whereby the threaded rod can move back and forth in the longitudinal direction of the tubular body.

What is claimed is:

1. A fast torque-switchable torque wrench comprising:
a tubular body;
a working head disposed at a front end of the tubular body;
a trip mechanism disposed in the tubular body and positioned at a rear end of the working head, whereby when the application force of the torque wrench reaches a set torque value, the trip mechanism provides a tripping effect;
an elastic member disposed in the tubular body and positioned behind the trip mechanism, the elastic member elastically abutting against the trip mechanism;
a first restriction section and a second restriction section disposed in the tubular body and positioned behind the elastic member;
a hollow handle, a front end of the handle being fitted with a rear end of the tubular body, the handle being rotatable on the tubular body;
a threaded rod having a main body, a thread being formed on an outer circumference of the main body, the main body of the threaded rod being disposed in the tubular body, a front end of the threaded rod directly or indirectly pressing the elastic member, the handle being connected with a rear end of the threaded rod, whereby when rotating the handle, the threaded rod being driven to move in a longitudinal direction of the tubular body;
a stop section connected with the main body of the threaded rod, the stop section being positioned in front of the first restriction section; and
a restriction component disposed on the main body of the threaded rod and positioned behind the second restriction section, the threaded rod being movable in the longitudinal direction of the tubular body between a front dead end and a rear dead end, when the threaded rod is positioned in the front dead end, the restriction component being stopped by the second restriction section, when the threaded rod is positioned in the rear dead end, the stop section being stopped by the first restriction section.

2. The torque wrench as claimed in claim 1, further comprising a restriction member fixedly disposed in the tubular body, the first restriction section being formed at a front end of the restriction member, the second restriction section being formed at a rear end of the restriction member.

3. The torque wrench as claimed in claim 2, wherein the restriction member has a through hole, a thread being formed on an inner circumferential wall of the through hole, the main body of the threaded rod being screwed in the through hole of the restriction member.

4. The torque wrench as claimed in claim 1, further comprising a connection assembly disposed at the rear end of the threaded rod, the restriction component being a restriction member positioned between the second restriction section and the connection assembly, when the threaded rod is moved forward, the connection assembly pushing the restriction member to move along with the threaded rod, when the threaded rod is positioned in the front dead end, the front end of the restriction member being stopped by the second restriction section.

5. The torque wrench as claimed in claim 2, further comprising a connection assembly disposed at the rear end of the threaded rod, the restriction component being a restriction member positioned between the second restriction section and the connection assembly, when the threaded rod is moved forward, the connection assembly pushing the restriction member to move along with the threaded rod, when the threaded rod is positioned in the front dead end, the front end of the restriction member being stopped by the second restriction section.

6. The torque wrench as claimed in claim 1, wherein the restriction component is fixedly connected with the main body of the threaded rod and movable with the threaded rod.

7. The torque wrench as claimed in claim 2, wherein the restriction component is fixedly connected with the main body of the threaded rod and movable with the threaded rod.

8. The torque wrench as claimed in claim 1, further comprising a connection member fixedly disposed in the handle, the connection member being formed with a longitudinal through hole, the rear end of the main body of the threaded rod being passed through the through hole of the connection member, the torque wrench further comprising a front fixing member and a rear fixing member, each of the front and rear fixing member being formed with a longitudinal threaded hole, the main body of the threaded rod being screwed in the threaded holes, a rear end face of the front fixing member and a front end face of the rear fixing member being respectively connected with the front and rear end faces of the connection member, whereby the connection member cannot be rotated relative to the front fixing member or the rear fixing member.

9. The torque wrench as claimed in claim 2, further comprising a connect ion member fixedly disposed in the handle, the connection member being formed with a longitudinal through hole, the rear end of the main body of the threaded rod being passed through the through hole of the connection member, the torque wrench further comprising a front fixing member and a rear fixing member, each of the front and rear fixing member being formed with a longitudinal threaded hole, the main body of the threaded rod being screwed in the threaded holes, a rear end face of the front fixing member and a front end face of the rear fixing member being respectively connected with the front and rear end faces of the connection member, whereby the connection member cannot be rotated relative to the front fixing member or the rear fixing member.

10. The torque wrench as claimed in claim 8, wherein the restriction component is the front fixing member.

11. The torque wrench as claimed in claim 9, wherein the restriction component is the front fixing member.

12. The torque wrench as claimed in claim 8, wherein each of the front and rear end faces of the connection member is formed with at least one tooth, each of the rear end face of the front fixing member and the front end face of the rear fixing member being formed with at least one first ratchet and at least one second ratchet, the first and second ratchets being arranged in reverse directions, the teeth of the front and rear end faces of the connection member being respectively engaged with the first and second ratchets of the front and rear fixing members.

13. The torque wrench as claimed in claim 9, wherein each of the front and rear end faces of the connection member is formed with at least one tooth, each of the rear end face of the front fixing member and the front end face of the rear fixing member being formed with at least one first ratchet and at least one second ratchet, the first and second ratchets being arranged in reverse directions, the teeth of the front and rear end faces of the connection member being respectively engaged with the first and second ratchets of the front and rear fixing members.

14. The torque wrench as claimed in claim 1, wherein multiple locating slots are annularly disposed on the outer circumference of the rear end of the tubular body, the locating slots extending in the longitudinal direction of the tubular body, at least one locating member being disposed through the outer circumference of the front end of the handle, the locating member being movable in a radial direction of the handle, the torque wrench further comprising an engagement member, the engagement member having an engagement position and a releasing position, a receiving section and a fastening section being disposed on an inner circumference of the engagement member, the engagement member being fitted on the outer circumference of the front end of the handle and movable in the longitudinal direction of the handle, when the engagement member is positioned in the engagement position, the fastening section pushing and pressing the locating member to make the locating member engaged in one of the locating slots of the tubular body, whereby the handle cannot be rotated, when the engagement member is positioned in the releasing position, the locating member leaving the locating slot of the tubular body to move into the receiving section of the engagement member, whereby the handle is rotatable around the tubular body.

15. The torque wrench as claimed in claim 2, wherein multiple locating slots are annularly disposed on the outer circumference of the rear end of the tubular body, the locating slots extending in the longitudinal direction of the tubular body, at least one locating member being disposed through the outer circumference of the front end of the handle, the locating member being movable in a radial direction of the handle, the torque wrench further comprising an engagement member, the engagement member having an engagement position and a releasing position, a receiving section and a fastening section being disposed on an inner circumference of the engagement member, the engagement member being fitted on the outer circumference of the front end of the handle and movable in the longitudinal direction of the handle, when the engagement member is positioned in the engagement position, the fastening section pushing and pressing the locating member to make the locating member engaged in one of the locating slots of the tubular body, whereby the handle cannot be rotated, when the engagement member is positioned in the releasing position, the locating member leaving the locating slot of the tubular body to move into the receiving section of the engagement member, whereby the handle is rotatable around the tubular body.

16. The torque wrench as claimed in claim 14, wherein a shoulder section is annularly formed on the outer circumference of the handle and a raised section is annularly disposed on the inner circumference of the engagement member, a spring being disposed between the handle and the engagement member, two ends of the spring respectively abutting against the raised section of the engagement member and the shoulder section of the handle.

17. The torque wrench as claimed in claim 15, wherein a shoulder section is annularly formed on the outer circumference of the handle and a raised section is annularly disposed on the inner circumference of the engagement member, a spring being disposed between the handle and the engagement member, two ends of the spring respectively abutting against the raised section of the engagement member and the shoulder section of the handle.
